(19) United States
(12) Patent Application Publication
(10) Pub. No.: US 2003/0163261 A1
(43) Pub. Date: Aug. 28, 2003

(54) Image evaluation device, image evaluation method, image order receiving device and image order receiving method

(75) Inventor: Takayuki Iida, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/372,390

(22) Filed: Feb. 25, 2003

(30) Foreign Application Priority Data
Feb. 26, 2002 (JP) 2002-49584

(51) Int. Cl. G09G 5/00

(52) U.S. Cl. 702/19; 345/716; 382/190

(57) ABSTRACT

The present invention provides a device and a method for easily ordering an image corresponding to an important scene for a user watching the moving images without increasing the burden on the user. A user sitting on a seat in a digital theater loads a scene marker including a storage component into a loading portion and attaches a wrist band comprising electrodes to his wrist. While the user is watching a film, an important scene determination component repeatedly measures skin resistance levels of the user and determines whether or not a scene the user is watching is important for the user. If it is determined that the scene is an important scene, information for specifying the scene is written into the scene marker via an I/F component. The written information may be used at a time of print order.

### BACKGROUND OF THE INVENTION

1. Field of the Invention

The present invention relates to an image evaluation device, an image evaluation method, an image order receiving device and an image order receiving method. In particular, the invention relates to an image evaluation method for determining an important scene for a user watching moving images, an image evaluation device which can apply the image evaluation method, an image order receiving method of receiving an order for an image corresponding to an important scene determined by the image evaluation device and an image order receiving device which can apply the image order receiving method.

2. Description of the Related Art

Digitalization of an image information source is proceeding, and high quality moving images for impressing more sharply such as a television program for digital theater or digital broadcasting and a net live relay broadcast on an Internet have been provided to users. In light of such circumstances, a demand for capturing, among the moving images provided to a user, a preferable scene or image by which the user was moved and for storing it as a photographic print, has been growing.

Regarding capture of the moving images, Japanese Patent Application Laid-Open (JP-A) No. 10-171027 suggests a technique, in which a user designates a frame to be printed while watching an video program, sends online frame identifying information and print order information to a print finishing operator, and then the print finishing operator obtains original image data of the frame to be printed from an image database of a broadcasting station, and produces a print.

In order to capture the moving images by the above-described technique, however, the user himself must perform an operation for capturing. For this reason, in order to capture a part of a scene of a movie played at a digital theater and order prints of the part, the user, who has come to the digital theater has to always be determining whether or not to order a scene, which is being played, to be printed while watching the film. If the user determines to order a print for a scene, the user must perform an operation for capturing the scene at an appropriate timing. Accordingly, if the above-described technique is applied to capturing of the moving images and print order thereof, a user receives a large burden, which is not realistic.

### SUMMARY OF THE INVENTION

The present invention has developed in light of the aforementioned, and a first object of the invention is to obtain image evaluation device and method that can precisely determine an important scene for a user who is watching the moving images without increasing the burden on the user.

A second object of the invention is to obtain image order receiving device and method that can easily order an image corresponding to an important scene for a user who is watching the moving images without increasing the burden on the user.

It is known that transient changes in skin resistance levels (SRL) of the human body occur by mental sweating on a skin surface due to various psychological stimuli, e.g., changes of emotions such as surprise, tension and excitation. It is also known that other bioinformation including pulse, temperature, blood pressure, brain wave and temporal changes of action potential of heart (electrocardiogram) changes depending on changes of emotions such as excitation. The inventors paid attention to the aforementioned facts and arrived at the invention by discovering that an important scene for a user watching the moving images can be determined from the moving images on the basis of the bioinformation of the user.

In order to accomplish the first object, an image evaluation device relating to a first aspect comprises a detection component for detecting bioinformation of a user who is viewing moving images; and a determination component for determining an important scene for the user from the moving images based on the bioinformation, which was detected by the detection component.

In accordance with the first aspect of the invention, the bioinformation of the user who is watching the moving images is detected by the detection component. The bioinformation detected by the detection component preferably correlates with changes of emotions of the user (i.e., changes depending on the changes of emotions of the user). At least one of skin resistance level, pulse, temperature, blood pressure, brain wave and temporal change of action potential of heart of the user may be used.

The determination component relating to the first aspect determines an important scene for a user from the moving images that the user is watching on the basis of the bioinformation of user detected by the detection component. Determination of important scene by the determination component may be performed, for example, by comparing the bioinformation detected by the detection component with a predetermined reference. If there provided predicted information regarding a degree of importance representing results that a producer of image contents determines, on a scene-by-scene basis of the image contents, whether or not a scene is an important scene for a large number of users, the important scene may be determined by taking this predicted information and the bioinformation into considerations.

In accordance with the first aspect of the invention, an important scene for a user is determined from the moving images the user is watching on the basis of bioinformation of the user. Thus, the user need not determine an important scene while watching the moving images. Accordingly, in accordance with the first aspect of the invention, an important scene for the user who is watching the moving images can be precisely determined without increasing the burden on the user.

In order to accomplish a second object, an image order receiving device relating to a second aspect of the invention comprises the image evaluation device of the first aspect; and a receiving component for receiving, when the user orders a specified image corresponding to the important scene determined by the determination component, an image order by information for identifying the specified image being sent to an image order processing device, which is connected to the receiving component via a communication line, receives the image order from the user and performs a predetermined processing.

Since the image order receiving device relating to the second aspect of the invention comprises the image evaluation device of the first aspect, the image order receiving device can, as in the first aspect of the invention, precisely determine an important scene for user who is watching the moving images without increasing the burden on the user.

When a user orders a specified image (which may be a still image or may be moving image) corresponding to the important scene determined by the determination component of the image evaluation device (a user may order to print the specified image or may order data of the specified image), the receiving component relating to the second aspect of the invention sends information for identifying the specified image to an image order processing device which is connected via a communication line and receives an image order from the user and then performs predetermined processings (e.g., production of photographic print of ordered image, processings accompanying such production to place an order with a print finishing operator for production of photographic print, processings accompanying such ordering, delivering data of ordered image to user, processings accompanying such delivering and calculation of fee for the image order) . In this way, the image order is received.

When a user would like to store, among the moving images the user watched, a specified image corresponding to the determined important scene as a photographic print or to obtain data of the specified image, the user orders the specified image and thus the image order is received. Accordingly, in accordance with the second aspect of the invention, a user watching the moving images can easily order an image corresponding to the important scene for the user without increasing the burden on the user.

The communication line relating to the second aspect of the invention may be a public communication line (or a network including the public communication line such as an Internet). If a dedicated communication line (or a network including the dedicated communication line) is used for the communication line, it is preferable because data with large capacity can be easily and stably transmitted in a short time. Further, since the data is hardly leaked, high security properties are high and receiving damage from computer viruses is difficult.

In accordance with the second aspect of the invention, it is preferable to further provide an image confirmation component that obtains image data corresponding to the important scene determined by the determination component of the image evaluation device and displays an image represented by the data as an image which can be ordered on a display component which is provided for the user to visually confirm. Thus, since a user can confirm images which can be ordered by visually confirming images displayed on the display component, the user can easily confirm the image corresponding to the determined important scene and select images that the user would like to order.

The image data is, for example, thumbnail image data (image data obtained by making a resolution of original image data low), and the image confirmation component preferably displays a thumbnail image represented by the obtained data on the display component. Thus, a processing for displaying images on the display component can be performed in a short time.

The image confirmation component can obtain the image data as follows. If the determination component of the image evaluation device is structured such that scene specifying information for specifying the determined important scene (e.g., information which represents a timing of reproducing the target scene when the moving images are reproduced with a start of reproduction being a reference or an ID of the image corresponding to the target scene) is stored in a storage component of portable device which is carried by a user and is provided with the storage component which can store at least information or that user identifying information stored in advance in the storage component of the portable device is read out from the storage component and the scene specifying information for specifying the determined important scene is associated with the read out user identifying information and stored in the storage component, the image confirmation component can read out the scene specifying information stored in the storage component of the portable device possessed by the user from the storage component, or can read out the user identifying information which is stored in the storage component of the portable device possessed by the user from the storage component, read out the scene specifying information that is associated with the read out user identifying information and stored in the storage component from the storage component, and can obtain the data of image corresponding to the important scene on the basis of the read out scene specifying information.

If the determination component of the image evaluation device is structured such that the data of the image corresponding to the determined important scene is stored in the storage component of portable device which is possessed by the user and is provided with the storage component which can store at least information or that the user identifying information stored in advance in the storage component of the portable device is read out from the storage component and the data of the image corresponding to the determined important scene is associated with the read out user identifying information and stored in the storage component, the image confirmation component can read out the image data stored in the storage component of the portable device possessed by the user from the storage component or can read out the user identifying information stored in the storage component of the portable device possessed by the user from the storage component and read out the image data associated with the read out user identifying information and stored in the storage component from the storage component.

In accordance with an image evaluation method relating to a third aspect of the invention, bioinformation of user who is watching the moving images is detected and an important scene for the user is determined from the moving images on the basis of the detected user's bioinformation. Thus, as in the first aspect of the invention, an important scene for user watching the moving images can be precisely determined without increasing the burden on the user.

An image order receiving method relating to a fourth aspect of the invention detects bioinformation of user who is watching the moving images; determines, among the moving images, an important scene for the user on the basis of the user's bioinformation detected; and if the user orders a specified image corresponding to the determined important scene, sends information for specifying the specified image to an image order processing device which receives an image order from the user and performs a predetermined processing and thus receives the image order. Thus, as in the second aspect of the invention, an image order for the important scene for user watching the moving images can be easily performed without increasing the burden on the user.

As described above, in accordance with the first and the third aspects of the invention, the bioinformation of user watching the moving images is detected and an important scene for user is determined on the basis of the detected bioinformation. Thus, there provided an excellent effect that it is possible to precisely determine an important scene for user watching the moving images without increasing the burden on the user.

In accordance with the second and the fourth aspects of the invention, the bioinformation of user watching the moving images is detected, an important scene for user is determined on the basis of the detected bioinformation. Then, when a user orders a specified image corresponding to the important scene, information for specifying the specified image is sent to an image order processing device and thus an image order is received. Accordingly, there provided an excellent effect that an image order for the important scene for user watching the moving images can be easily performed without increasing the burden on the user.

Data of image corresponding to the important scene is obtained and an image represented by the data is displayed on a display component as an image, which can be ordered. Thus, in addition to the above-described effects, there provided an effect that a user can easily confirm the image corresponding to a scene determined as the important scene and easily select the image that the user would like to order.

Further, thumbnail image data is obtained and the thumbnail image data is displayed on the display component. Thus, in addition to the above-described effects, there provided an effect that a processing for displaying images on the display component can be performed in a short time.

### BRIEF DESCRIPTION OF THE DRAWINGS

FIG. 1 is a block diagram showing an example of schematic structure of image delivery/order processing system relating to an embodiment of the present invention.

FIG. 2A is a block diagram showing a schematic structure of capture control device.

FIG. 2B is a timing chart showing an example of writing scene specifying information in the capture control device.

FIG. 3A is a block diagram showing an example of schematic structure of card type scene marker.

FIG. 3B is a block diagram showing an example of schematic structure of scene marker, which is built in a cellular telephone.

FIG. 4 is a sequence view showing an example of print order sequence for film, which is played at a digital theater.

FIG. 5 is a flowchart showing the contents of moving image capture processing performed in the capture control device.

FIG. 6 is a flowchart showing the contents of image order receiving/delivering processing performed in an image order processing device.

FIGS. 7A to 7D are image diagrams showing print order for film which is played at a digital theater.

### DESCRIPTION OF THE PREFERRED EMBODIMENTS

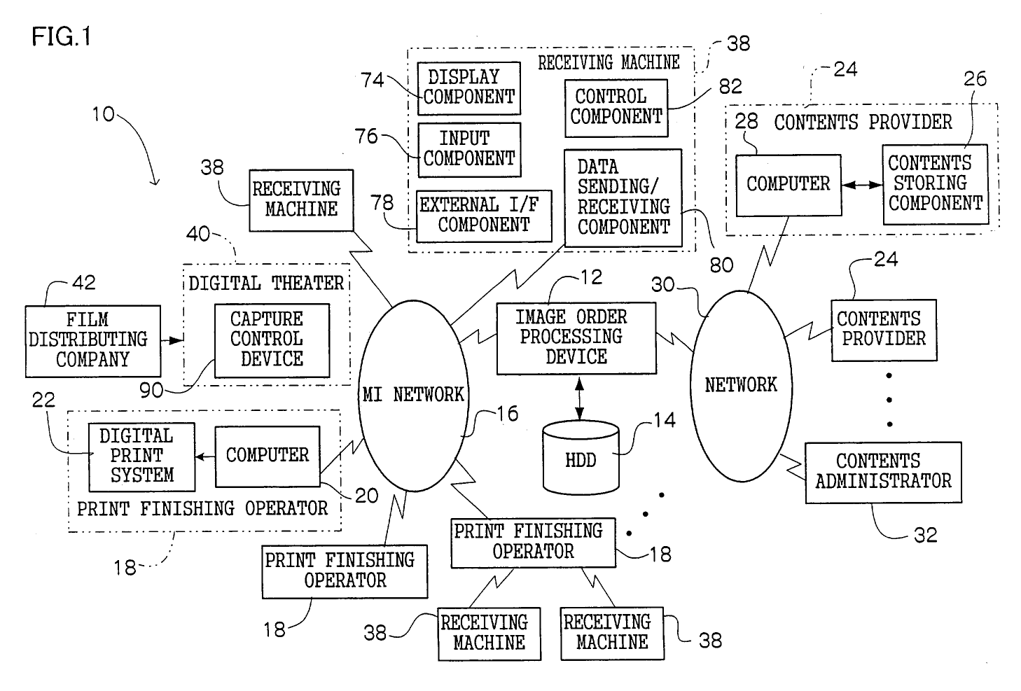

Hereinafter, an example of embodiments of the present invention will be described in detail with reference to the drawings. FIG. 1 shows an image delivery/order processing system 10 relating to this embodiment. The image delivery/order processing system 10 is a system which allows a user to order prints of desired image contents among various image contents delivered via various delivery components to the user. Hereinafter, print order for, among various image contents, a film (moving images) played at a digital theater will be described.

[Print Order Processing System]

Firstly, a component for processing a print order from a user in the image delivery/order processing system 10 will be described. The image delivery/order processing system 10 includes an image order processing device 12 which is installed at a large photo lab or the like existing at main cities in Japan. The image order processing device 12 is formed by a computer such as a workstation or the like. In the image order processing device 12, although not illustrated, CPU, ROM, RAM and input/output ports are connected together via buses, and various input/output devices including a display such as a CRT, a LCD or the like, a mouse, a keyboard, a hard disk device (HDD) 14 (see FIG. 1), a CD-ROM driver and a communication control device (e.g., a modem or a router) are connected to the input/output ports. By the CPU of the computer carrying out a predetermined program, the image order processing device functions. (A communication control device of) the image order processing device 12 is connected to an MI network 16 which is configured by a high-speed and mass dedicated communication line. Connected to the MI network 16 are computers 20 (e.g., personal computers (PCs) or the like) possessed by print finishing operators 18 existing all over the country. Instead of the MI network, a computer network such as an Internet or the like may be employed.

The print finishing operator 18 has a digital printing system 22 including a film scanner for reading images recorded in a photographic film and a digital printer for performing a print finishing processing of recording an image indicated by image data in recording material such as a photographic printing paper or the like. The digital printing system 22 is connected to the computer 20, and the print finishing processing can be performed by using the image data received by the computer 20 via the MI network.

[Image Contents Delivery]

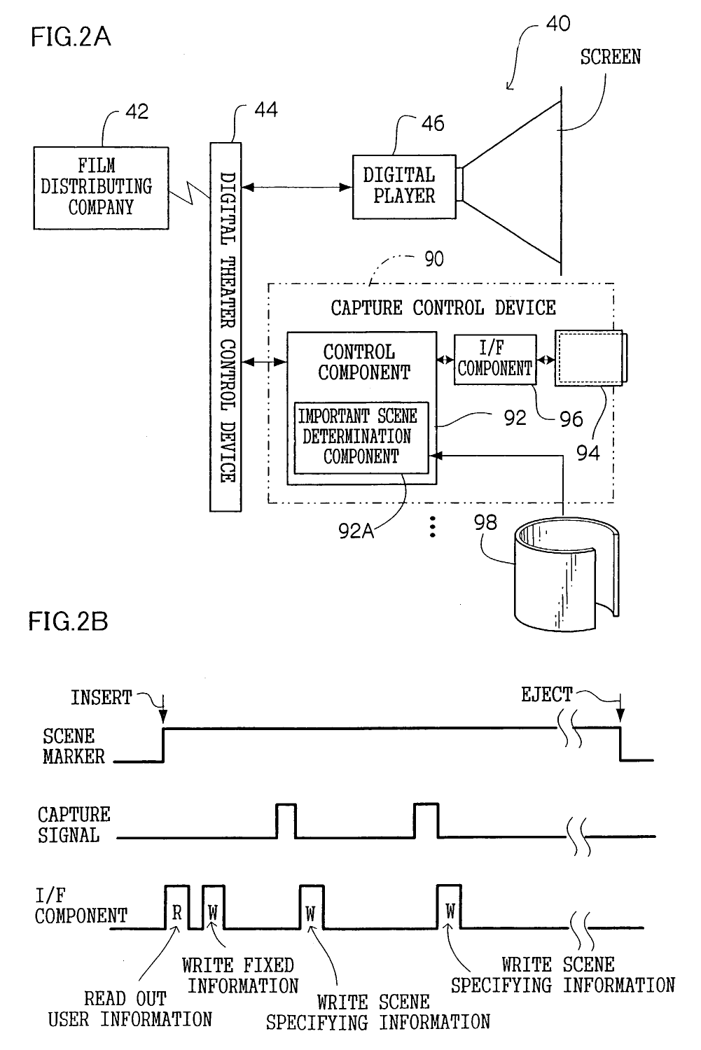

A film which is played at a digital theater 40 serving as a contents deliverer is produced by a film producer serving as a contents provider. Then, as shown in FIG. 2A, the film is sent, as moving image data, from a film distributing company 42 to the digital theater 40 (contents deliverer) via a communication line. The digital theater 40 is provided with a digital theater control device 44. The moving image data of the film received from the film distributing company 42 is temporarily stored in a memory (not shown) of the digital theater control device 44.

The film distributing company 42 relating to this embodiment sends not only the aforementioned moving image data of the film but also thumbnail moving image data that frame images of the moving image data are processed so as to have a low resolution to the digital theater 40. The thumbnail moving image data is also stored in the memory of the digital theater control device 44.

A digital player 46 is connected to the digital theater control device 44. The digital theater control device 44 reads out the moving image data of film from the memory device and sends the same to the digital player 46 at a timing corresponding to a predetermined play schedule. The digital player 46 projects a film (moving image) on a screen by using the received moving image data. In this way, a film is played (delivered) at the digital theater 40 and the film is provided to a user who comes to the digital theater 40 as the moving images.

[Management of Image Contents]

The image contents delivered by a contents deliverer to a user are managed (stored) in the image delivery/order processing system 10 so as to respond to a print order from the user. Namely, as shown by a reference numeral “24” in FIG. 1, the contents provider (e.g., film distributing company 42) has a contents storing component 26 which is formed by a storage component such as a HDD or the like and in which data (data of image with high quality and high resolution and information about usage fee) of image contained in the image contents provided to the contents deliverer (for example, if the image contents is a film (moving images), each frame image of the film (moving images)) is stored. The information about usage fee represents an image usage fee when using the high quality image data in order to produce a photographic print. The image usage fee is paid to the contents provider who is a copyright holder. When the image includes a predetermined person as a subject, a portion of the image usage fee might be paid to the person as a fee for the right of image.

The contents storing component 26 is connected to a computer 28, and the computer 28 is connected to a network 30. The image order processing device 12 is also connected to the network 30. The computer 28 can communicate via the network 30 to the image order processing device 12.

The network 30 may be a public telephone line network or may be a dedicated communication line network. Further, the network 30 may be a cellular telephone network in which a large number of switching equipment are connected together via a communication line and a large number of base stations which are placed at different locations and govern wireless communication to cellular telephones are respectively connected to any of the switching equipment. Moreover, the network 30 may be a computer network (e.g., an Internet) in which a large number of web servers including a work station or the like are connected together via a communication line. Alternatively, the network 30 may include all of or a portion of the aforementioned networks.

In accordance with the invention, the image contents delivered to a user may not be managed (or stored) by the contents provider. A contents administrator (indicated by a reference numeral “32” in FIG. 1) who is entrusted by the contents provider may manage the image contents. Of course, the image contents may be managed by the contents deliverer.

[Equipment used for Print Order]

In order to print order for film (or a part of scenes) played at the digital theater 40, a capture control device placed at the digital theater 40, a scene marker possessed by a user (corresponding to a portable device) and a receiving equipment (corresponding to a receiving component) are used. Firstly, a description will be given of the scene marker hereinafter.

The scene marker is a tool for enabling writing of information for specifying an image ordered to be printed. When a user orders a print via a receiving equipment (which will be described later), information written into a scene marker possessed by the user is read out by the receiving equipment and sent to the image order processing device 12. Thus, an image ordered to be printed can be specified by the image order processing device 12 without requiring the user to perform a complicated operation such as oral transmission of the image ordered to be printed at a time of print order.

The scene marker is desirably a card type for a user to easily have and carry. The simplest configuration of the scene marker is a magnetic card. Nevertheless, an existing magnetic card has drawbacks in that it has limited storable amount of information (data of only 72 characters), it is easily forged and a malicious third party can illegally read out data from it with ease.

For this reason, taking that other information (e.g., user's information that the user must transmit at a time of print order), as well as the image specifying information is written into the scene marker into consideration, the scene marker is desirably formed by an IC card. An existing IC card has a mass storage component which is capable of storing a few thousands characters and a CPU contained therein. Further, a program can be incorporated into the IC card. Thus, it is possible to prevent illegal reading of data by the malicious third party by securely setting a key for invoking the information stored in the chip. Further, the IC card cannot be substantially forged and thus is appropriate as a scene marker.

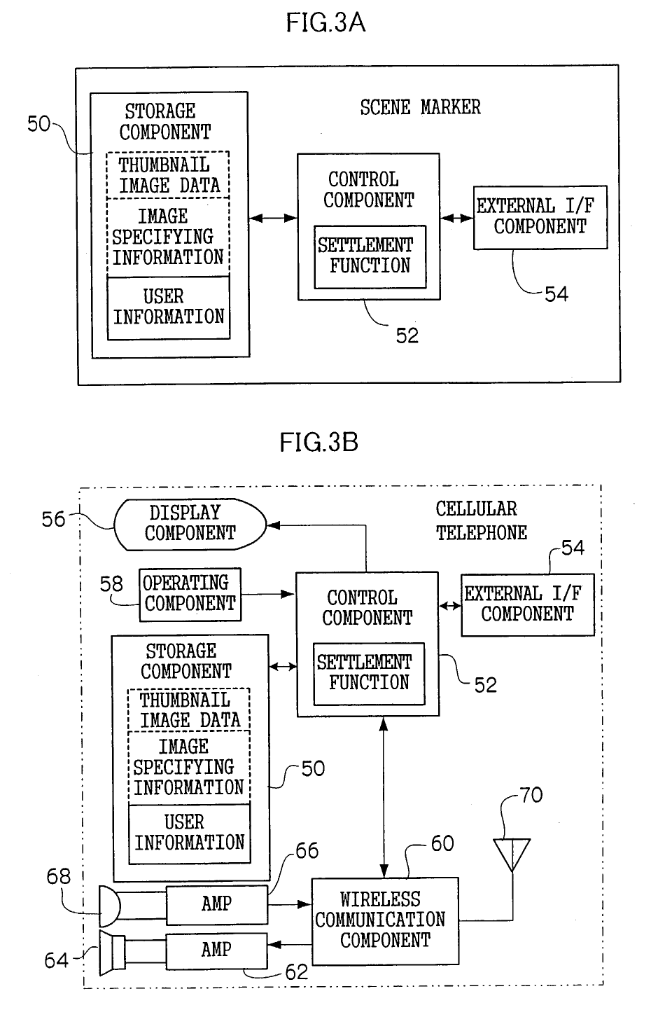

FIG. 3A shows an example of structure of card type scene marker formed by an IC card. The scene marker is configured to include a storage component 50 which can store any information including the image specifying information, a control component 52 including a CPU or the like and an external I/F component 54 for sending/receiving the information to and from outside.

The interface between the IC card and the outside is roughly classified into a contact type interface and a contactless type interface. The contactless type interface is further classified into a close coupled type with the maximum communication distance of around 2 mm, a vicinity type with the maximum communication distance of around 10 cm, a proximity type with the maximum communication distance of around 70 cm and a microwave type with the maximum communication distance of a few meters (which is capable of communicating even if a user having it is moving and which can utilize a standard such as Bluetooth or HomeRF). Any of the aforementioned types may be used for the external I/F of the IC card for scene marker. It is preferable to use the contactless type having a relatively long communication distance, because a user need not take out the card type scene marker and set it to a predetermined position of the receiving equipment at a time of print order.

Personal information about a user possessing the scene marker (user information: corresponding to user identifying information) is stored in advance in the storage component 50. The user information may be configured to include at least one of user's ID for identifying an individual user, user's name, user's address and user's contact address (which may be any one of user's telephone number, user's FAX number and user's electronic mail address). When the user orders a print with the receiving equipment, the user information stored in the storage component 50 is read out from the storage component 50 of the scene marker by the receiving equipment and sent to the image order processing device 12.

As shown in FIG. 3A, the control component 52 preferably has a settlement function. A settlement method may be a prepaid method or may be a credit method. Thus, settlement can be also completed by the receiving equipment when a user orders a print. Personal authentication and settlement may be performed by utilizing services provided by a trusted third party.

The scene marker is not limited to the card type, and the function of the scene marker may be built in a cellular telephone. Alternatively, mobile information equipment including a PDA (Personal Digital Assistants), a wearable computer (a computer which is operable while carried by a user), a mobile computer and a cellular telephone having a function of connecting to a computer network such as an Internet or the like can function as the scene marker. FIG. 3B shows an example of structure of scene marker, which is built in a cellular telephone.

The scene marker includes the above-described storage component 50, the control component 52 and the external I/F component 54. Connected to the control component 52 are a display component 56 which is formed by an LCD and can display various information including an image, an operating component 58 including an electric power switch and a ten key and a wireless communication component 60. A speaker 64 is connected via an amplifier 62 to the wireless communication component 60. A microphone 68 is also connected via an amplifier 66 to the wireless communication component 60. Further, an antenna 70 is also connected to the wireless communication component 60. The wireless communication component 60 has a function of wireless communicating, under control of the control component 52, via the antenna 70 to a base station connected to a public telephone line by electromagnetic wave within a frequency band which is predetermined for cellular telephone. Currently, the cellular telephone is widely used. Thus, by the function of scene marker being incorporated into the cellular telephone, as compared to a case that user carries the scene marker itself, it is possible to prevent the user from feeling an unpleasant feeling of carrying the scene marker.

The scene marker may be spread by being distributed to a user for free by persons concerned including a contents deliverer, an operator at large photo lab and a print finishing operator. In the aspect in which the cellular telephone or the mobile information equipment functions as the scene marker, the scene marker may be spread by distributing a program which enables the cellular telephone or the mobile information equipment to operate as the scene marker for free (by distributing a recording medium with the program recorded therein for free or by permitting downloading of the program for free).

Next, a capture control device 90 placed at the digital theater 40 will be described with reference to FIG. 2A. The capture control device 90 has the function of image evaluation device relating to the invention.

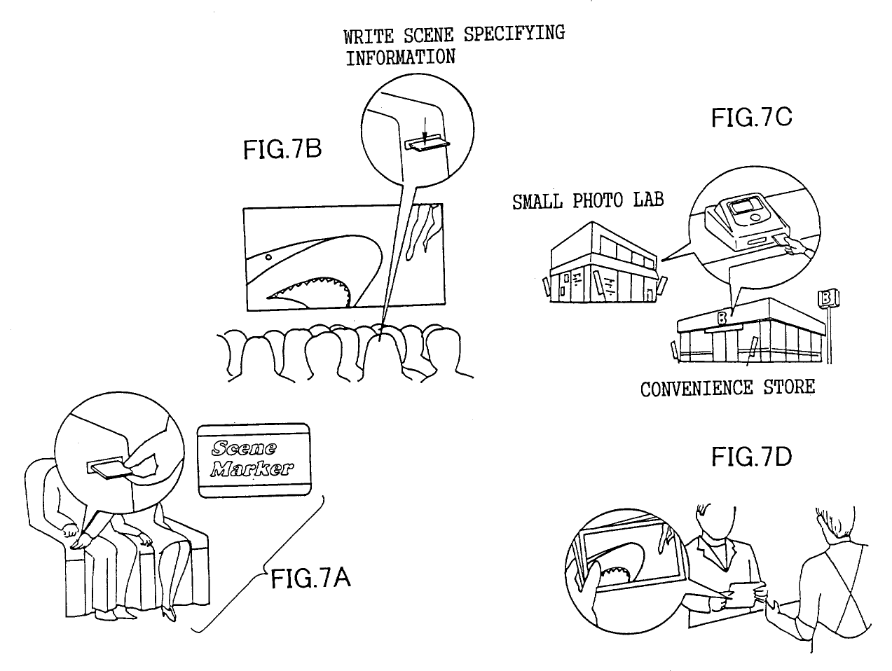

The capture control device 90 is provided at each of seats in the digital theater 40. (The capture control device needs not to be provided at all seats.) The capture control device 90 is configured so as to include a loading portion 94 (see FIG. 7A) into which the user sitting on a seat loads a scene marker, an I/F component 96 which sends/receives information to and from the scene marker loaded into the loading portion 94, a wrist band 98 which is attached to a wrist or the like of the user sitting on the seat and watching a film and a control component 92 which is configured such that a CPU, a ROM, a RAM and an input/output port are connected together and which is connected to the I/F component 96 and the wrist band 98. The control component 92 is connected to the digital theater control device 44.

Although not illustrated, the wrist band 98 is provided with a plurality of electrodes at its inner surface, which contacts user's skin when attached to the user. The control component 92 includes an important scene determination component 92A therein. (The important scene determination component 92A is effected by the CPU implementing a predetermined program.) The important scene determination component 92A periodically measures electric resistance values of the plurality of electrodes (i.e., user's skin resistance levels Rm). Then, on the basis of results of measurement, the important scene determination component 92A determines whether or not a scene that a user is watching (i.e., a scene that is being projected on a screen) is important for the user. The wrist band 98 corresponds to a detection component of the invention (in particular, a detection component) and the important scene determination component 92A corresponds to a determination component of the invention.

If the important scene determination component 92A determines that the scene that the user is watching is an important scene, the control component 92 obtains scene specifying information for specifying the determined important scene and thumbnail moving image data which is formed by making a resolution of moving image data of the determined important scene low from the digital theater control device 44. Then, the control component 92 writes the scene specifying information and the thumbnail moving image data via the I/F component 96 into the storage component 50 of scene marker.

Referring to FIG. 2A, cases of contact type interface between a scene marker and an outside and of contactless type interface with relatively short communication distance are illustrated. If the interface between a scene marker and an outside is a contactless type interface with relatively long communication distance, the I/F component 96 of the capture control device 90 may be configured by a wireless communication component performing wireless communication with a scene marker.

The receiving equipment 38 (see FIG. 1) that is used when a part of scenes of film, which is played at the digital theater 40, are ordered to be printed is connected to the MI network 16. (The receiving equipment 38 may be directly connected to the MI network or may be connected via the computer 20 of print finishing operator to the MI network 16:see FIG. 1.) The receiving equipment 38 is installed at any places in Japan including a DPE shop, a convenience store, a shopping mall, a theme park and the like. (An exterior of the receiving equipment 38 is shown in FIG. 7C.)

The receiving equipment 38 includes a display component 74 which is formed by a CRT or an LCD and can display images, an input component 76 for the user to input various types of information, an external I/F component 78 which can send/receive the information to and from a scene marker, a data sending/receiving component 80 which can send/receive the data via the MI network 16 to and from the image order processing device 12 and a control component 82 which controls operations of the various components of the receiving equipment 38.

[Print Order Sequence for Film Played at Digital Theater]

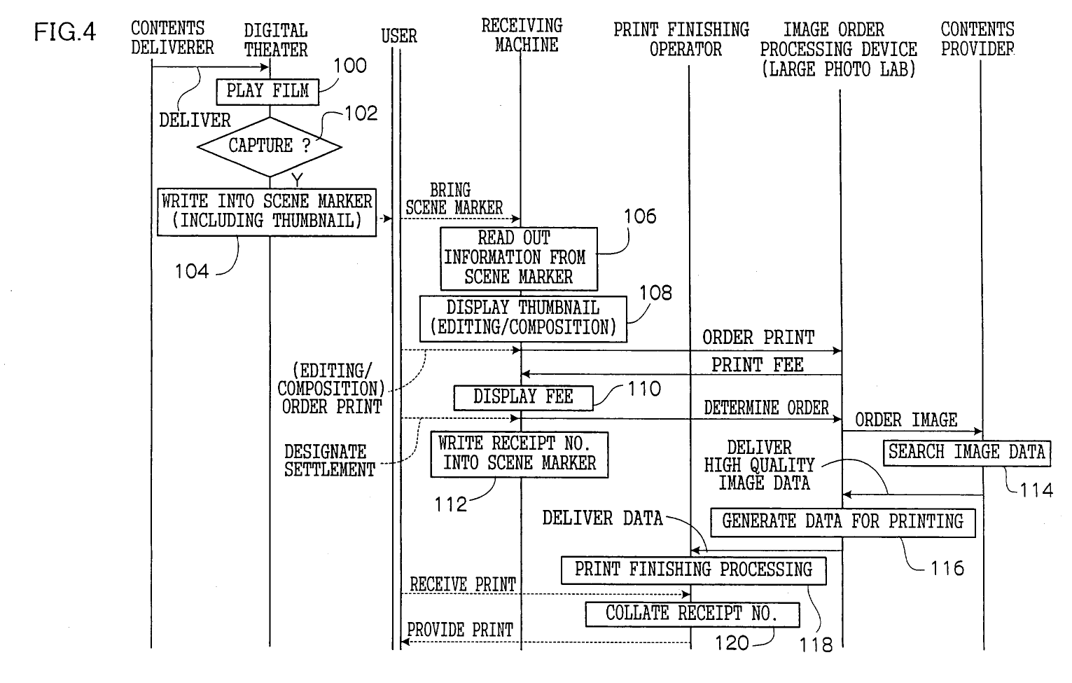

Next, an example of print order sequence for a film, which is played at the digital theater 40, will be described with reference to FIG. 4. As already described, a film which is produced by a film producer is sent as moving image data from a film distributing company 42 via a communication line to the digital theater 40 and then temporarily stored in a memory of the digital theater control device 44. Thereafter, the film is played by being sent to the digital player 46 in accordance with a predetermined play schedule (e.g., see step 100 of FIG. 4).

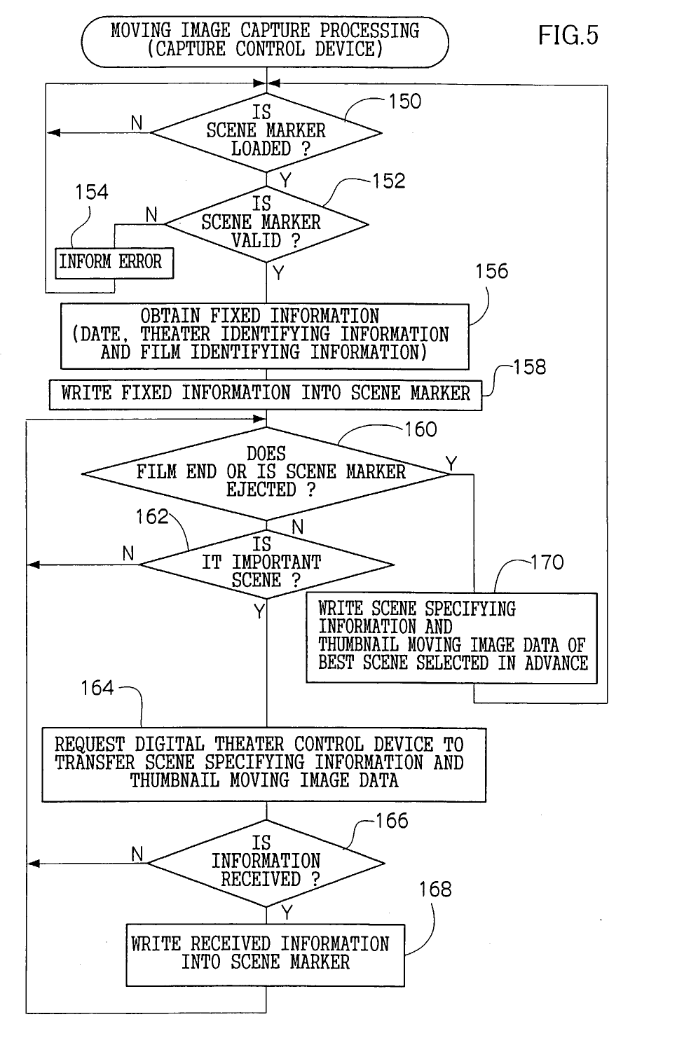

When a film is played at the digital theater 40, an moving image capture processing shown in FIG. 5 is carried out in the control component 92 of the capture control device 90 which is provided at each of seats in the digital theater 40. In accordance with the moving image capture processing, first in step 150, whether or not a scene marker is loaded into the loading portion 94 is determined and a process is placed in a waiting state until the determination of step 150 is affirmed. When the user coming to the digital theater 40 sits on a seat, loads a scene marker possessed by the user into the loading portion 94 (see FIG. 7B) and attaches the wrist band 98 to the user's wrist, the determination of step 150 is affirmed and then the process proceeds to step 152.

In step 152, whether or not a card which is loaded into the loading portion 94 is a scene marker is determined by reading out user information or the like which is stored in advance in the storage component 50 of the scene marker by the I/F component 96 (see “read out user information” in FIG. 2B). If it is determined in step 152 that the card loaded into the loading portion 94 is not a scene marker, the process proceeds to step 154. Then, an error is announced by, e.g., sound of buzzer and the process returns to step 150.

If it is confirmed that the card loaded into the loading portion 94 is a scene marker, the process proceeds from step 152 to step 156. In step 156, a date, theater identifying information for identifying an individual theater (the digital theater 40) and film identifying information for identifying a film to be played (e.g., a film's title, a film identifying code or the like) are obtained as fixed information to be written into the scene marker. The date can be obtained from a calendar contained in the control component 92. The theater identifying information and the film identifying information can be obtained from the digital theater control device 44. In step 158, the obtained fixed information is written into the scene marker via the I/F component 96 (see “write fixed information” in FIG. 2B).

In step 160, it is determined whether or not the film ends or whether or not the scene marker is instructed to be ejected from the loading portion 94. If the determination of step 160 is negative, the process proceeds to step 162. In step 162, it is determined whether or not a scene that the user is watching is important for the user by determining whether or not a capture signal is outputted from the important scene determination component 92A.

The important scene determination component 92A measures electric resistance values (i.e., the user's skin resistance levels Rm) between a plurality of electrodes provided at the wrist band 98 in a state of the wrist band 98 being attached to the user's wrist and determines whether or not the skin resistance levels Rm are equal to or smaller than a predetermined value Rm0. Further, the important scene determination component 92A calculates a rate of change ΔRm of the skin resistance levels by using results of measurement of the skin resistance levels Rm and determines whether or not the rate of change ΔRm of the skin resistance levels is equal to or smaller than a predetermined value ΔRm0 (a predetermined value ΔRm0 has a negative sign). A series of such determinations is repeated.

The user who is watching a film (or other moving images) mentally sweats on a surface of skin because of changes of emotions induced by the film, including surprise, tension, excitation and the like. The skin resistance level Rm of the user decreases depending on an amount of sweating at a time of mental sweating. For this reason, the important scene determination component 92A determines that a scene, which a user is watching, is important for the user if the skin resistance value Rm is equal to or smaller than a predetermined value Rm0 or if the rate of change ΔRm of the skin resistance levels is equal to or smaller than a predetermined value ΔRm0, and then outputs a capture signal.

Taking personal differences of the user's skin resistance levels Rm into consideration, the skin resistance level Rm that is measured immediately after a user attaches a wrist band to the user's wrist is stored as a reference value RmREF. Then, the above-described determination (determination of important scene on the basis of a difference between the reference value RmREF and the skin resistance value Rm) may be performed by using values obtained by normalizing the skin resistance levels Rm measured while a film is being played by the reference value RmREF. Further, a prediction of whether or not it will be an important scene for most users may be performed for every scene of played film and results of prediction may be stored as predicted information regarding a degree of importance. An important scene may be determined by taking such predicted information regarding a degree of importance into consideration.

If the determination in step 162 is negative, the process returns to step 160 and the steps 160 and 162 are repeated until either determination is affirmed. If a capture signal is outputted from the important scene determination component 92A, the answer to the step 162 is affirmed and the process proceeds to step 164. In step 164, the digital theater control device 44 is required to transfer the scene specifying information for specifying a scene which is determined as an important scene by the important scene determination component 92A and the thumbnail moving image data corresponding to the scene.

The scene specified by the scene specifying information (i.e., the scene represented by the thumbnail moving image data which is transferred from the digital theater control device 44) may be scenes of the played film that were projected on a screen for predetermined seconds before and after a timing a capture signal is outputted from the important scene determination component 92A or may be the scene that was being projected on a screen at a timing that a capture signal is outputted from the important scene determination component 92A, of a large number of scenes obtained by classifying in advance the played film by situations.

In step 166, it is determined whether or not the above-described information is received from the digital theater control device 44 and the process is placed in a waiting state until the determination of step 166 is affirmed. When the scene specifying information and the thumbnail moving image data are received from the digital theater control device 44, the determination in step 166 is affirmed and then the process proceeds to step 168. In step 168, the received information is written into the storage component 50 of the scene marker and then the process returns step 160. Accordingly, for every time when a capture signal is outputted from the important scene determination component 92A and the determination in step 162 is affirmed, steps 164 to 168 are performed and the scene specifying information and the thumbnail moving image data are written into the storage component 50 of scene marker (see steps 102 and 104 in FIG. 4, and FIG. 7B)

The steps 164 to 168 correspond to aspects, in a determination component, of storing the scene specifying information and the image data corresponding to the important scene (thumbnail moving image data) in a storage component of the portable device.

When the user instructs to eject a scene marker from the loading portion 94 because the film ends or the user leaves the digital theater 40, the determination in step 160 is affirmed and the process proceeds to step 170. In step 170, the scene specifying information and the thumbnail moving image data (or data obtained by making a resolution of still image data low) of best scenes of the film that the user was watching that are selected in advance and stored in the control component 92 of the capture control device 90 are written into the storage component 50 of scene marker. Then, the process returns to step 150.

Accordingly, by the above-described moving image capture processing being performed, information shown in the following table 1, for example will be automatically written into the storage component 50 of scene marker possessed by the user who watched the film at the digital theater 40. The table 1 shows an example that a capture time (i.e., a time when a capture signal is outputted from the important scene determination component 92A) is also written into the storage component 50 of scene marker.

TABLE 1

| | | MOVING | SCENE |
|---|---|---|---|
| FIXED | | IMAGE | SPECIFYING |
| INFORMATION | CAPTURE TIME | DATA | INFORMATION |
| DATE, THEATER | FIRST | IMG 1 | D1 |
| IDENTIFYING | hh:mm:ss | | |
| INFORMATION, | SECOND | IMG 2 | D2 |
| FILM IDENTIFYING | hh:mm:ss | | |
| INFORMATION | . | . | . |
| | . | . | . |
| | | IMGX | DX |
| | | | (SELECTED |
| | | | BEST SCENES) |

The user who has watched the film at the digital theater 40 visits a place where the receiving equipment 38 is installed with the scene marker into which the above-described information is written by the capture control device 90 (see FIG. 7C). Then, if an interface between the scene marker and an outside is contact type or contactless type with relatively short communication distance, the user loads the scene marker into a loading portion of the receiving equipment 38 and then inputs information for instructing to display images ordered to be printed (images with the scene specifying information being written into the scene marker) via an input component 76 of the receiving equipment 38.

Then, the control component 82 of the receiving equipment 38 reads out the user information, the fixed information, the scene specifying information and the thumbnail moving image data from the storage component 50 of the scene marker loaded into the loading portion via the external I/F component 78 (see step 106 in FIG. 4). The receiving equipment 38 reproduces and displays thumbnail moving images on the display component 74 by using the thumbnail moving image data read out from the scene marker (see step 108 in FIG. 4). If a plurality of thumbnail moving image data are written into a scene marker, thumbnail moving images represented by the respective data may be sequentially reproduced and displayed on the display component 74. Alternatively, a display screen of the display component 74 is divided into a plurality of display components and then different thumbnail moving images may be reproduced and displayed in parallel on the respective display components. Above-described reproduction and display of thumbnail moving images corresponds to an image confirmation component.

In this way, by visually confirming thumbnail moving images displayed on the display component 74, the user can confirm important scenes that are automatically captured by the capture control device 90 while watching the film at the digital theater 40 and the best scenes that are selected in advance. If scenes that a user would like to memorize by storing them as photographic prints are included among the thumbnail moving images displayed on the display component 74, the user specifies the best scenes for the user as images ordered to be printed by performing, via the input component 76 of the receiving equipment 38, operations for instructing pause or slow down of reproduction and display of the thumbnail moving images. When the images ordered to be printed are determined by specifying the best scenes, the user inputs, via the input component 76, information for instructing print order and information representing detailed contents of print order (e.g., a print size and the number of prints).

If the user desires manipulation of image ordered to be printed or composition with another image, the user also inputs information for instructing manipulation or composition of image ordered to be printed. Image data presented to the user by displaying images that can compose with the image ordered to be printed (e.g., template for making a New Year's card or a calendar) on the display component 74 may be sent from the image order processing device 12 to the receiving equipment 38 or may be stored in advance in the receiving equipment 38.

When contents of print order desired by the user is determined by the user inputting various information via the input component 76, the receiving equipment 38 adds to information indicating that a print order is provided the image specifying information for specifying the image ordered to be printed (the fixed information read out from the storage component 50 of scene marker, a frame ID of the image ordered to be printed (an ID for identifying each frame image of film; instead of the frame ID, the time required to play the film from the beginning may be used.)), the information indicating the contents of determined print order (if the user instructs manipulation or composition of image, information indicating such instruction is also added.), the user information read out from the storage component 50 of scene marker and the receiving equipment ID for identifying the receiving equipment 38 itself. Then, the receiving equipment 38 sends the resultant information to the image order processing device 12.

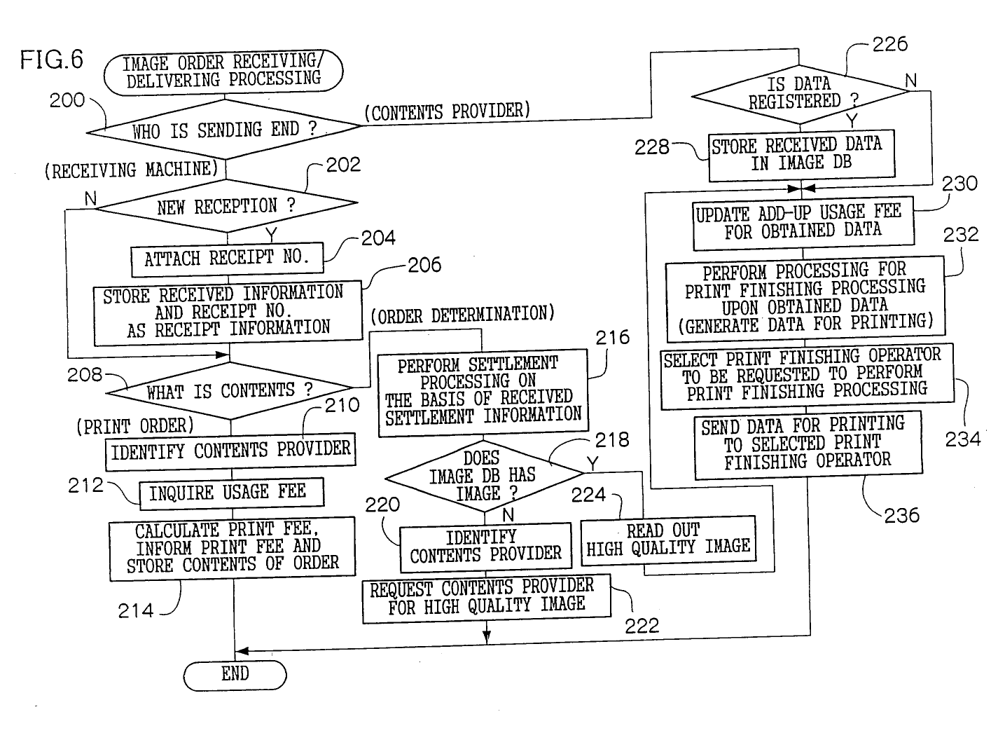

When the image order processing device 12 receives any information from outside, it carries out an image order receiving/delivering processing shown in FIG. 6. In the image order receiving/delivering processing, first in step 200, it is determined whether a sending end of the received information is a receiving equipment 38 or a contents provider (or a contents administrator). When the sending end of the information is the receiving equipment 38, the process proceeds to step 202, and it is determined on the basis of the contents of the received information whether or not the received information is information corresponding to a new print order.

Since the image order processing device 12 receives a large number of print orders and processes them in parallel, a receipt no. for identifying each print order is attached to each of all received print orders. The receipt no. of the corresponding print order is attached to the information with respect to the corresponding print order with the receipt number attached thereto that is sent/received between the image order processing device 12 and the receiving equipment 38 or the contents provider.

For this reason, if a receipt no. is not attached to the received information, the determination in step 202 is affirmed and the process proceeds to step 204. In step 204, a receipt no. is attached to a new print order corresponding to the received information. In step 206, the information received from the receiving equipment 38 is associated with the receipt no. and stored as receipt information in a memory or the like. Thereafter, the process proceeds to step 208. If the determination in step 202 is negative, the process proceeds to step 208 without performing any processings.

In step 208, the contents of notice represented by the information received from the receiving equipment 38 is determined on the basis of the contents of the information received from the receiving equipment 38. In step 208, if it is determined that the information received from the receiving equipment 38 is information for noticing a print order, the process proceeds to step 210. In step 210, the contents provider (or administrator) which stores the image data of the image ordered to be printed is identified on the basis of the image specifying information received from the receiving equipment 38.

Identification of the contents provider (or administrator) is carried out as follows. Namely, a contents provider/administrator DB in which the image specifying information for specifying the image whose data is stored in the contents storing component 26 by the contents provider (or administrator) is associated with an ID for identifying each contents provider (or administrator) and stored in advance is provided at the HDD 14. Then, the received image specifying information is collated with the image specifying information stored in the contents provider/administrator DB and the contents provider (or administrator) which stores the image data of the image ordered to be printed which is represented by the received image specifying information is searched. In step 212, the image specifying information and a receipt no. are added to the information, which represents an inquiry of image usage fee. Then, the resultant information is sent via the network 30 to the computer 28 of the contents provider (or administrator) identified in step 210. In this way, the image usage fee for the image ordered to be printed is inquired.

The computer 28 of the contents provider (or administrator) which receives the above-described information searches the contents storing component 26 by using the received image specifying information as a key, and reads out the usage fee information for the image ordered to be printed from the contents storing component 26. Then, the computer 28 attaches the received receipt no. to the read out usage fee information and sends the same via the network 30 to the image order processing device 12. When the usage fee information is received from the contents provider (or administrator) via the network 30, the process proceeds to step 214. In step 214, a fee for producing photographic prints is calculated on the basis of the information representing the contents of the print order received from the receiving equipment 38. Then, by adding the image usage fee which is represented by the usage information received from the contents provider (or administrator) to the fee for producing photographic prints, a print fee to be charged to a user is calculated. The information representing the calculated print fee is sent to the receiving equipment 38, so that the print fee is noticed to the receiving equipment 38. Then, the image order receiving/delivering processing temporarily ends.

The receiving equipment 38 which has received the information representing the print fee displays the print fee represented by the received information on the display component 74 (see step 110 in FIG. 4). Thus, a user can easily confirm the print fee. When a user who has confirmed the print fee inputs information for instructing settlement via the input component 76, the print order which is instructed by the user is determined. If a scene marker possessed by a user includes a function of settlement, the receiving equipment 38 carries out a processing for settlement of the determined print order.

Namely, according to the scene marker which includes the function of settlement, settlement information (i.e., information required for settlement) is written in advance into, e.g., a storage component such as a non-volatile memory or the like contained in the control component 52. If a settlement method is a credit type, credit information indicating the user's credit card no. may be used as the settlement information. Alternatively, if the settlement method is a prepaid type, usage degree information indicating remaining usage degree available for print order may be used as the settlement information.

The receiving equipment 38 communicates with the control component 52 of scene marker possessed by a user in accordance with a predetermined procedure so as to request the control component 52 to send the settlement information. Then, the receiving equipment 38 receives the settlement information sent from the control component 52. The receiving equipment 38 attaches the settlement information received from the scene marker and a receipt no. to the information, which represents that, a print order has been determined and sends resultant information to the image order processing device 12. Further, the receiving equipment 38 writes the receipt no. into the storage component 50 of the scene marker for collation at a time of providing prints (see step 112 in FIG. 4).

The image order processing device 12 which has received the information carries out successively the steps 200, 202 and 208 in the image order receiving/delivering processing (FIG. 6), and the process proceeds from step 208 to step 216. In step 216, a settlement processing is performed on the basis of the settlement information, which is included in the information received from the receiving equipment 38.

If the settlement method is a credit type, the credit information is sent from the receiving equipment 38 as the settlement information. Then, the image order processing device 12 sends the credit information received from the receiving equipment 38, the user information stored as the receipt information and the information about received print fee to a computer (not shown) of settlement authorization which is connected via a communication line to the network 30 in order to ask for the settlement processing. The image order processing device 12 confirms that a report that the settlement processing had been completed has been received. Then, the image order processing device 12 informs the receiving equipment 38 that the settlement has been completed. At this time, the receiving equipment 38 informs a user that the settlement for the received print order has been completed by displaying a message on the display component 74.

If the settlement method is a prepaid type, usage degree information is sent from the receiving equipment 38 as the settlement information. Then, the image order processing device 12 subtracts usage degree corresponding to the print fee for received order from the usage degree indicated by the usage degree information received from the receiving equipment 38, and sends the usage degree information indicating the usage degree after subtraction to the receiving equipment 38. At this time, the receiving equipment 38 communicates with the control component 52 of scene marker in accordance with a predetermine procedure so as to store the usage degree information received from the image order processing device 12 in the scene marker. Further, the receiving equipment 38 informs a user of the remaining usage degree and that the settlement for the received print order has been completed by displaying a message on the display component 74.

In the image order processing device 12, when the settlement processing is completed, the process proceeds to step 218. In step 218, it is determined on the basis of the image specifying information of the image ordered to be printed which is stored as the receipt information whether or not the high quality image data of the image ordered to be printed is stored in an image database (image DB) which is provided at the HDD 14 in order to store high quality image data of images frequently ordered to be printed. If the determination in step 218 is negative, the process proceeds to step 220. In step 220, similar to the above-described step 210, the contents provider (or administrator) storing the image data of the image ordered to be printed is identified on the basis of the image specifying information stored as the receipt information.

In step 222, the image specifying information and a receipt no. are attached to the information which represents a request for sending the high quality image data and the resultant information is sent via the network 30 to the computer 28 of the contents provider (or administrator) identified in step 220. Thus, the contents provider (or administrator) is requested to send the high quality image data of the image ordered to be printed. Then, the image order receiving/delivering processing temporally ends.

The computer 28 of the contents provider (or administrator) which receives the information searches the contents storing component 26 by using the received image specifying information as a key, and reads out the high quality image data of the image ordered to be printed from the contents storing component 26 (see step 114 in FIG. 4). The computer 28 attaches a receipt no. to the read out high quality image data and sends via the network 30 to the image order processing device 12.

Since the network 30 relating to the embodiment has a lower degree of security than that of the MI network 16, in order to prevent leakage of the high quality image data to the third party other than the contents provider (or administrator) and the image order processing device (i.e., large photo lab), the high quality image data sent from the contents provider (or administrator) is desirably the encrypted image data. Encryption of the image data may be performed after reading out the image data from the contents storing component 26. Alternatively, the image data, which is encrypted in advance, may be stored in the contents storing component 26.

The image order processing device 12 which has received the information proceeds from step 200 to step 226 in the image order receiving/delivering processing (FIG. 6) if a sending end of the received information is the computer 28 of the contents provider (or administrator) In step 226, it is determined whether or not the received high quality image data is recorded in the image DB. When the image ordered to be printed is an image which is highly frequently ordered to be printed, the determination in step 226 is affirmed, and the process proceeds to step 228. In step 228, the received high quality image data is recorded in the image DB, and the process proceeds to step 230. If the determination in step 226 is negative, the process proceeds to step 230 without performing any processing. Consequently, when the image whose high quality image data is recorded in the image DB is ordered again to be printed, the information of the image needs not to be requested again to the contents provider (or administrator).

In the above-described step 218, when the high quality image data of the image ordered to be printed that is required by the receiving equipment 38 to be sent is stored in the image DB, the determination in step 218 is affirmed and the process proceeds to step 224. In step 224, the high quality image data of the image ordered to be printed is read out from the image DB and then the process proceeds to step 230. Consequently, the frequency of requesting the contents provider (or administrator) to send the high quality image data can be effectively decreased.

In this embodiment, an add-up value of image usage fee for each of the images ordered by a user to produce photographic prints which should be paid for the contents provider or the like is stored in the HDD 14. In step 230, a processing for updating the add-up value for the corresponding image usage fee is performed because the high quality image data obtained by receiving from the contents provider (or administrator) or reading out from the image DB is used for the print order. The add-up value for the image usage fee is read out periodically (e.g., for every month) and added for each payee (e.g., contents provider or administrator, or payee of fee for the right of image). Then, the add-up value is automatically transferred to an account, which is designated by each payee in advance. The add-up value for the image usage fee is cleared (i.e., is made zero) for each time the image usage fee is transferred.

In step 232, a processing for generating image data for printing (i.e., image data that enables a print finishing operator to easily carry out a print finishing processing) from the obtained high quality image data is performed (see step 116 in FIG. 4). The processing for generating the image data for printing includes decoding (releasing of encryption) of the encrypted high quality image data which is received from the contents provider (or administrator).

Encryption and decoding of the data are usually performed by using a “key”. In a common key system in which the same key is used both in encryption and decoding of the data, high speed encryption processing can be achieved. Nevertheless, when the data encrypted by a sender is decoded by a receiver, the key possessed by the sender must correspond to the key the possessed by receiver. Thus, there is a problem in that a security is decreased when the key is sent or received between the sender and the receiver.

In a public key system, a cryptographic key used for encryption is different from a decoding key used for decoding. The cryptographic key is made public and the decoding key is kept in secret. A sender encrypts a send data by using a public key of a receiver. The receiver decodes the received data by using a secret key. Thus, the system has high security. For this reason, in this embodiment, encryption and decoding of the high quality image data are performed by the public key system. An international version of PGP (Pretty Good Privacy) and S/MINE (Secure Multipurpose Internet Mail Extension) are known as a known encryption software adopting a public key system, and such softwares may be used.

The high quality image data has a large amount of data due to its high resolution and it is assumed that it takes a long time to send/receive the data. Thus, when sending the high quality image data from the contents provider (or administrator) to the image order processing device 12, the sent data is preferably compressed. In this case, in step 232, decompression (decoding) of the compressed high quality image data received from the contents provider (or administrator) is performed as one of processings for generating the image data for printing. Various types of known algorithms may be utilized for compression and decompression of the data.

A processing in accordance with the contents of the print order from a user may be performed in step 232 as one of the processings for generating the image data for printing. Specific examples of such processing include resolution conversion (pixel density conversion) depending on a print size designated by a user, editing (e.g., trimming) of the image data in accordance with a designation from the user and composition of the image data (composition of the image data with a template).

Further, an image processing for image quality enhancement may be performed as one of the processings for generating the image data for printing in step 232. Specific examples of such image processing include a color/density correction processing including tone conversion or color conversion, a color space conversion for reproducing the image ordered to be printed on a recording medium such as a printing paper or the like so as to have an appropriate color tint, a hypertone processing for compressing tone of extremely low frequency luminance component of the image, a hypersharpness processing for emphasizing a sharpness while suppressing granularity, a defective portion correction processing for correcting defectives of the image due to defective pixels of photographing sensor and the like. Consequently, an image quality of photographic print made by a print finishing operator can be enhanced.

By performing at least one of the above-described processings, when realizing an environment that images of various types of image contents can be ordered to be printed, equipment that should be installed to each of print finishing operators can be simplified. Further, the image delivery/order processing system 10 relating to this embodiment can be easily constructed.

If it takes a long time to receive the image data for printing sent from the image order processing device 12 because a data communication speed between the image order processing device 12 and the computer 20 of print finishing operator is slow, which hinders a service of the print finishing operator, a processing for temporally compressing the generated image data may be performed as one of the processings for generating the image data for printing. Alternatively, if a communication line between the image order processing device 12 and the computer 20 of the print finishing operator has low security, a processing for temporally encrypting the generated image data may be performed.

In step 234, a print finishing operator which will be asked to perform a print finishing processing is selected. Specifically, the print finishing operator in the neighborhood of a user's address may be selected with reference to the user information which is stored as one of the receipt information. Alternatively, when a user designates the print finishing operator via the input component 76 of the receiving equipment 38, the designated print finishing operator may be selected. In step 236, the information representing the contents of print order, the user information and a receipt no. are added to the image data for printing generated in step 232, and the resultant information is sent via the MI network 16 to the print finishing operator selected in step 234.

The print finishing operator who receives the image data for printing via the MI network 16 and the computer 20 performs a print finishing process in the digital print system 22 in accordance with the contents of the print order represented by the received information by using the image data for printing received from the image order processing device 12 (see step 118 in FIG. 4). Then, when a user visits a predetermined place for receiving prints (place where the receiving equipment 38 is installed such as a DPE shop, a convenience store or the like), the user information and the receipt no. that are stored in the storage component 50 of scene marker possessed by the user are collated with respect to the user information and the receipt no. that are received from the image order processing device 12 (see step 120 in FIG. 4). In this way, the user is identified. Then, results of print order (photographic prints produced by the print finishing processing) are provided to the user (see FIG. 7D).

Although a case in which the scene marker has a function of settlement is described above, the invention is not limited to this case. A print finishing operator may deliver produced photographic prints as payment on delivery. Alternatively, a user may settle an account when coming to a shop of print finishing operator in exchange for photographic prints. If the settlement function of scene marker is utilized and an account is settled online at a time when a print order is determined, it is preferable because the photographic prints can be rapidly provided to the user without delivering money.

An aspect that the control component 92 of the capture control device 90 writes the scene specifying information into a scene marker when a capture signal is outputted from the important scene determination component 92A has been described. Nevertheless, the invention is not limited to this aspect. For every time a capture signal is inputted from the important scene determination component 92A, the scene specifying information may be associated with the user information and stored in a storage component which is different from the scene marker. In this case, the receiving equipment 38 searches, at a time of receiving a print order, the storage component by using the user information as a key so as to obtain the target scene specifying information.

The above-described aspect corresponds to an aspect of “storing in a storage component”. In accordance with the above-described aspect, since the scene specifying information and the like need not to be written into a scene marker, the user needs not to have a scene marker. Thus, the invention may be applied to a case in which a user has only a simple recording medium with only the user information being recorded therein (e.g., a magnetic card or a card with a barcode being recorded therein: such card may enable accounting like a credit card).

The invention may be applied to a case that the user does not have a scene marker nor a simple recording medium. For example, when the scene specifying information is stored in the storage component, the scene specifying information is associated with, instead of the user information, an identification code which is automatically set in order to distinguish individual users. Then, a receipt with the identification code being printed thereon is provided to the user. (Alternatively, a printer which outputs the receipt may be embedded into a sheet.) When a print order is received, the identification code printed on the receipt possessed by a user is read and the storage component is searched by using the read identification code as a key. Consequently, the target scene specifying information may be obtained.

When the user does not have a scene marker nor other simple recording medium, the user must input the user information for each print order such that severe burden is placed on the user. When the user has only the simple recording medium, the user information may be read out or forged by a malicious third party. For this reason, a user desirably has a card type scene marker or a scene marker which is built in a cellular telephone. If the user has the scene marker, there is provided an advantage that a receiver can be precisely identified when the photographic prints are provided to the receiver. Even if a place where the user orders prints is far from a place where the user receives the photographic prints, the provide processing of photographic prints can be precisely provided to the user.

In the image order processing device 12, various services (restoring of points or provision of service information) may be provided to each of the users, depending on the state that a user uses the image delivery/order processing system 10, by using the user information sent from the receiving equipment 38 or the like.

Although an example in which an image DB is provided only at a large photo lab (image order processing device 12) has been described, the invention is not limited to this example. Especially in an aspect that the receiving equipment 38 is connected via the computer 20 of print finishing operator to the MI network 16, the image DB may also be provided at the computer 20 of the print finishing operator.

Although a case in which orders for producing prints are made as image orders relating to the invention has been described, the invention is not limited to this case. The invention may be applied to cases of ordering a recording medium with the image data of image ordered to be printed recorded therein and of downloading the image data of image ordered to be printed.

A case that the important scenes for a user are determined among a film which is played at the digital theater 40 has been described. Nevertheless, the moving images relating to the invention may include, for example, images broadcasted by digital broadcasting and various types of live images delivered from live sites. In addition to images that are temporarily made into moving image data and then reproduced and displayed, actual scenes of events which have actually taken place such as sports events, which took place at athletic fields and concerts may be used. The invention may be applied to a case in which important scenes for the user are determined among the aforementioned moving images.

A case in which the important scenes for the user are determined on the basis of the user's skin resistance level Rm which is one of the pieces of the user's bioinformation has been described. Nevertheless, the invention is not limited to this case. One of various bioinformation such as pulse, temperature, blood pressure, brain wave and temporal change of action potential of heart (electrocardiogram) or several types of such bioinformation may be detected. Then, on the basis of the detected bioinformation, the important scenes for the user may be determined. Pulse, temperature and blood pressure as well as the skin resistance level may be easily and concurrently measured by the wrist band 98 or similar measurement equipment.

Although a case that the wrist band 98 for detecting the bioinformation in a state of being attached to user's wrist is provided as a detection component relating to the invention has been described, the invention is not limited to this case. The detection component may contact other parts of user other than user's wrist. Further, the detection component may have, other than circular configuration such as a wrist band, any configuration including a mount portion at which a part of user's body is placed.

Although a case in which the user whose bioinformation is detected is the same as the user who orders prints has been described, the invention is not limited to this case. For example, among people watching a soccer game at a soccer field, people in different situations (e.g., a soccer commentator (e.g., an ex-player), supporter for a home-team and supporter for an away team) are selected as representatives of people. Biological signals of the selected people (referred to as observed persons) during their watching the game are detected. Then, important scenes that are common to the observed persons (common important scenes) are determined by the biological signals of the observed persons. Further, if there provided the individual important scenes for a specified observed person (e.g., scenes determined to be important for the supporter and scenes determined to be important for the soccer commentator (ex-player) ), the individual important scenes for each of the observed persons are combined with the common important scenes. Then, resultant scenes may be provided to users (e.g., other people) other than the observed persons as important scenes for people in various situations. In accordance with the above aspect, the moving images relating to the invention are not images that are temporarily made into data as the moving image data and then reproduced and displayed but actual scenes. Thus, images that are selected, in accordance with results of determination of important scenes, among a large number of images photographed by photographer at the soccer field may be used as the images ordered to be printed.

What is claimed is:

1. An image evaluation device comprising:
a detection component for detecting bioinformation of a user who is viewing moving images; and
a determination component for determining an important scene for the user from the moving images based on the bioinformation, which was detected by the detection component.

2. The image evaluation device of claim 1, wherein the detection component detects, as the bioinformation, at least one of the user's skin resistance level, pulse, temperature, blood pressure, brain wave and temporary change of action potential of a heart of the user.

3. The image evaluation device of claim 1, wherein the detection component comprises a wrist band that is attached to the user.

4. The image evaluation device of claim 1, wherein the detection component comprises a mount portion at which a part of the user's body is mounted.

5. The image evaluation device of claim 3, wherein the detection component measures a skin resistance level of the user immediately after the wrist band is attached to the user, stores the skin resistance level as a reference value and determines the important scene by using a value obtained by normalizing, with the reference value, the skin resistance level, which is measured while the user is watching the moving images.

6. An image order receiving device comprising:
the image evaluation device of claim 1; and
a receiving component for receiving, when the user orders a specified image corresponding to the important scene determined by the determination component, an image order by information for identifying the specified image being sent to an image order processing device, which is connected to the receiving component via a communication line, receives the image order from the user and performs a predetermined processing.

7. The image order receiving device of claim 6 further comprising:
a display component disposed so that the user is able to visually confirm an image displayed thereon; and
an image confirmation component for obtaining image data corresponding to the important scene determined by the determination component, and for making the display component displays the image data as an orderable image.

8. The image order receiving device of claim 7, wherein the image data comprises thumbnail image data and the image confirmation component makes the display component display a thumbnail image represented by the obtained image data.

9. The image order receiving device of claim 7, wherein the user possesses a portable device comprising at least a storage component, which can store information,
the determination component one of (A) makes the storage component store scene specifying information for specifying the determined important scene, and (B) reads out, from the storage component, user identifying information, which was stored in the storage component in advance, associates the read out user identifying information with the scene specifying information, and makes the storage component store the associated read out user identifying information and scene specifying information, and
the image confirmation component reads out the scene specifying information, which was one of stored in the storage component and associated with the user identifying information and stored in the storage component, and based on the read out scene specifying information, obtains image data corresponding to the important scene.

10. The image order receiving device of claim 7, wherein the user possesses a portable device comprising at least a storage component, which can store information,
the determination component one of (A) makes the storage component store scene specifying information for specifying the determined important scene, and (B) reads out, from the storage component, user identifying information, which was stored in the storage component in advance, associates the read out user identifying information with the scene specifying information, and makes the storage component store the associated read out user identifying information and scene specifying information, and
the image confirmation component reads out, from the storage component, the stored user identifying information and the scene specifying information, which is associated with the read out user identifying information, from the storage component and obtains the data of the image corresponding to the important scene based on the read out scene specifying information.

11. The image order receiving device of claim 7, wherein, the user possesses a portable device comprising at least a storage component, which can store information,
the determination component makes the storage component store image data corresponding to the determined important scene, and
the image confirmation component reads out, from the storage component, the stored image data and the image data, which is associated with a read out user identifying information and stored in the storage component.

12. The image order receiving device of claim 7, wherein, the user possesses a portable device comprising at least a storage component, which can store information,
the determination component reads out user identifying information, which was stored in the storage component in advance, associates the read out user identification information with image data, which corresponds to the determined important scene, and makes the storage component store the corresponded read out user identification information and image data, and
the image confirmation component reads out from the storage component the associated user identifying information.

13. An image evaluation method comprising the steps of:
detecting bioinformation of a user who is watching moving images; and
determining an important scene for the user, among the moving images, based on the detected bioinformation of the user.

14. The image evaluation method of claim 13, wherein in the detecting step, the detected user's bioinformation is a skin resistance level of the user which is detected by a wrist band attached to the user,
the image evaluation method further comprising the step of:
measuring a skin resistance level immediately after the wrist band is attached to the user and storing the measured skin resistance level as a reference value;
the determining step determines the important scene by using a value that is obtained by normalizing, with the reference value, the skin resistance level measured in the detecting step while the user is watching the moving images.

15. An image order receiving method comprising the steps of:
detecting bioinformation of user who is watching the moving images;
determining an important scene for the user, among the moving images, based on the detected user's bioinformation; and
if the user orders a specified image corresponding to the determined important scene, sending information for specifying the specified image to an image order processing device, which receives an image order from the user and performs a predetermined processing.

16. The image order receiving method of claim 15 further comprising the step of:
obtaining data of image corresponding to the important scene determined in the determining step and displaying the image represented by the data on a display component which is provided for the user to visually confirm the image.

17. The image order receiving method of claim 16, wherein the image data comprises thumbnail image data and the displaying step displays the thumbnail image data represented by the obtained data.

18. The image order receiving method of claim 16, wherein the determining step stores scene specifying information for specifying the determined important scene in a storage component of portable device which is possessed by the user and is provided with the storage component that can store at least information, and
the displaying step reads out the scene specifying information stored in the storage component of the portable device and obtains data of image corresponding to the important scene on the basis of the read out scene specifying information.

19. The image order receiving method of claim 16, wherein the determining step reads out user identifying information stored in advance in the storage component of the portable device, which is possessed by the user and is provided with the storage component that can store at least information from the storage component, associates the scene specifying information with the read out user identifying information and stores the associated scene specifying information and user identifying information in the storage component, and
the displaying step reads out, from the storage component, the user identifying information stored in the storage component of the portable device and the scene specifying information that is associated with the read out user identifying information and obtains the data of image corresponding to the important scene on the basis of the read out scene specifying information.
